(19) United States
(12) Patent Application Publication
(10) Pub. No.: US 2005/0055142 A1
(43) Pub. Date: Mar. 10, 2005

(54) Turf image marker

(76) Inventors: Richard McMurtry, Redland (GB); Ben McMurtry, Horsley (GB)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/948,909

(22) Filed: Sep. 24, 2004

Related U.S. Application Data
(63) Continuation of application No. PCT/GB03/00347, filed on Jan. 28, 2003.

(30) Foreign Application Priority Data
Mar. 26, 2002 (GB) 0207107.4

(51) Int. Cl. G06F 7/00

(52) U.S. Cl. 701/29

(57) ABSTRACT

An autonomous ground maintenance vehicle is provided with maintenance equipment for performing a ground maintenance operation, such as mowing and storing grass, a marking device that includes a delivery structure for applying a marking material to the ground, a guidance mechanism for guiding the ground maintenance vehicle, and a position sensor for determining the position of the vehicle. The marking device is controlled in response to the position of the vehicle according to the position sensor.

### CROSS-REFERENCE TO RELATED APPLICATIONS

This application is a continuation of International Application No. PCT/GB03/00347, filed Jan. 28, 2003, which claims priority from U.K. Patent Application No. 0207107.4, filed Mar. 26, 2002. The disclosures of both applications are incorporated herein by reference.

### BACKGROUND OF THE INVENTION

This invention relates to an autonomous ground maintenance vehicle.

Conventionally, advertisements and logos have been marked on sports fields using wet paints or powders dispensed either with a walk behind sprayer or such like or a paint brush. Generally, line marking devices and other ground maintenance machines are independent vehicles used at different stages of the maintenance process by the groundsman or user. Usually the turfed area of a playing surface is cut, aerated or brushed with a machine adapted specifically for the job before the lines or advertising logo are put on the surface. Typically the lines defining the sports area are produced by moving a ground marking device along a reference line, usually a taut cord or line tied between two reference points for a straight line and a length of rope attached to the ground marking device about a center in order to describe a circle.

Complex and intricate images such as advertisements are conventionally applied to the surface of a pitch or surrounding area using a manually operated apparatus for dispensing paint, and usually employing one of two methods of producing a multicolored pattern. Firstly, images may be applied manually with the aid of large stencils or secondly with a grid referencing system whereby a small-scale image is divided into small constituent cells by a grid in order to aid the operator to apply an enlarged version of the image onto the surface. Advertisements or logos are typically produced on grassland or soil using paints and the invention not only relates to this method, but also makes use of other techniques such as using fertilizer, weed killer, seeds or ploughing to change the surface characteristics relative to the immediate surroundings. Both forms of paint marking require human control and preparation, and skill to mark out the image accurately. This typically takes considerable time especially if one playing surface is used for two or more sports.

There is also known in the art marking systems for mobile ground maintenance equipment, for example an agricultural sprayer. These systems provide simple marks which roughly correspond to the periphery of the treated area to help the operator to identify which areas have already been treated. There is also known in the art more complex imaging systems. U.S. Pat. No. 6,299,934 provides a paint spray system including a paint sprayer program and a GPS-controlled paint sprayer. A location comparator is provided for detecting a location match between the geographical locations of a drawing pattern and the current GPS based location. U.S. Pat. No. 5,681,129 provides an advertising display method involving marking grass sports fields by bending the grass blades in order to form an image or a word.

### SUMMARY OF THE INVENTION

According to the present invention there is provided an autonomous ground maintenance vehicle comprising guidance means for guiding the ground maintenance vehicle on the ground area to be maintained, position sensing means for determining the position of the vehicle, maintenance equipment for performing a ground maintenance operation, marking means for marking the ground, and control means for the marking means, the control means being responsive to the position sensing means for controlling the marking means to mark the ground at predetermined positions.

The provision of the marking means on the ground maintenance vehicle overcomes the difficulties with present ground marking practices. The number of machines required for land maintenance, which usually matches the number of different operations, may be reduced. This reduces the time required for change over and set up, and also reduces vehicle maintenance and required storage area. Additionally, time intensive labor is reduced by using a simple computer interface for the preparation and planning of size, composition and colors etc. The accuracy of such an autonomous vehicle thus eliminates the requirement for stencils or physical grid referencing systems. The vehicle may operate within a working region that is defined by at least three reference markers disposed adjacent to the periphery of the working region. The vehicle may have detecting means for detecting the position of the said vehicle relative to said reference points. The reference points may be either light retro-reflectors, light emitters, ultrasound receivers or emitters, or radio signal emitters. Alternatively, or in addition, the vehicle may derive the distance and direction to aid navigation from odometry. A direction detecting means may be provided for detecting the vehicle's direction of travel.

The vehicle may be equipped with a grass cutting device or any other turf maintenance equipment such as aerators and hollow corers. The different types of maintenance equipment may be permanently fixed to the vehicle, detachable or interchangeable. The marking means may comprise dispensing apparatus adapted to dispense one or more of the following materials: paint, fertilizer, herbicides or seeds. Alternatively the marking means may be capable of physically changing the surface by use of a plough tool or such like. The dispensing apparatus may be equipped with at least one dispensing nozzle for dispensing fluid or powder and may be positioned at the front, rear or sides of the vehicle. The setting of the or each nozzle may be manually or automatically adjustable.

The dispensing means may comprise a single nozzle fixed to the vehicle, or a plurality of nozzles fixed to the vehicle. Alternatively, the nozzle or nozzles may be mounted on means enabling the or each nozzle to traverse across the width of the vehicle. Alternatively a ground engaging wheel or roller may be used to dispense the fluid or powder onto the ground surface.

The fluid and/or powder dispensed onto the ground surface by the dispensing means may be of one color so as to apply a monochromatic image or a plurality of colors so as to apply a multicolored image. The or each nozzle may be capable of mixing fluids or powders before dispensing to generate a new color.

Marking may also be achieved by growth modifying materials such as herbicides, pesticides or seeds. If such materials are used they may also be dispensed from a container or box via one or more closable outlet openings positioned at any point along the base. It may be arranged that gravity tends to feed material through the opening(s), and/or there may be one or more mechanisms for conveying the material towards the outlet or outlets. For example there may be one or more exit openings controlled by one or more cylindrical brushes or paddles. They may be helical or straight in form and, if the maintenance equipment is a grass cutter, positioned anywhere along the base, front or rear of the catcher box. Means are provided to contra-rotate them about the longitudinal axis at such a rate that uneven spread may be eliminated or reduced. Other possibilities include a panel or panels flapping to and fro about a horizontal axis or reciprocating like a piston, a fan or fans, one or more fanned discs with vertical axes, or rake panels. Alternatively or additionally material may be fed towards the or each opening by gravity, belted conveyor, walking floor, shuffle floor, or one or more fans inclined at any angle. In the case of a belted conveyor, conveying surface of the belt may be smooth or provided with ridges, flights or other features recognized in belt design for assisting with the conveying of material by the belt. Gravity or any of the other methods can be assisted by vibrating the container with a reciprocating cam internally or externally acting on the container or by the vibrating motion of a vehicle as it travels.

Use may also be made of a splitting container which hinges open at a set rate such that, when activated, uneven spread may be eliminated or reduced.

If the maintenance equipment is a grass cutter, the arrangement may be such that material is passed out of the container so that it falls onto the cutting means of the grass cutter whose normal motion acts to distribute the material.

All of the above methods may be controlled in such a way that the rate of expulsion from the container may be varied by a computer controller. The dispensing apparatus may be an integral part of the vehicle, an attachment or a trailer mounted device.

In order that the autonomous turf or agricultural maintenance machine can mark images by turning over the land to expose soil a plough device may be fitted to the vehicle. The device may have one or more blades which may be lowered and raised individually or together as the computer controller dictates so that an image may be formed as the vehicle travels forwards. The device may be an integral part of the vehicle, an attachment or a trailer mounted device.

In order to apply images onto the ground surface using any of the previously mentioned materials, or by up turn of the surface to generate the image, the machine may operate following any of the following methods:

Most complex color or monochrome images such as advertisements or logos are either round or rectangular in design and may be marked on the ground by a computer program rasterizing the required image in either a round or square spiral starting in the center of the image. The rasterized spiral may then be further rasterized at 90° to the direction of travel of the vehicle. The rasterization of the image may vary in resolution. This digitization of the image may then be translated into a series of instructions to the dispensing apparatus which relate directly to the forward motion of the vehicle so that an image is generated as the vehicle moves from the center of the spiral outwards. The start of the spiral may be generated by turning the vehicle on a small radius and only using the portion of the dispensing apparatus closest to the center and then expanding the portion as the vehicle travels around until the full width of the dispensing apparatus is used.

An alternative method of translating complex color or monochrome images onto the ground is to employ a computer program rasterizing the required image to the width of the vehicle's dispensing apparatus (i.e. in the travel direction) and then further rasterizing the widths at 90° to the travel direction. This digitization of the image may then be translated into a series of instructions to the dispensing apparatus which relate directly to the forward motion of the vehicle so that an image is generated as the vehicle moves back and forth displacing itself by one dispensing apparatus width every change in direction. The dispensing apparatus may be capable of dispensing different colors in such a manner that the interface between colors is clearly defined without passing over the same surface twice.

A further method of translating complex color or monochrome images to the ground is to use the method of rasterization as described previously, but with the material being dispensed in such a manner that the vehicle travels over each vehicles width band once for each color that makes up the full color image before displacing itself one dispensing apparatus width to the next image band.

The first of the last three methods is the most efficient as no time is wasted in turning the vehicle and therefore the power requirements are also reduced.

The machine may travel on a predetermined path whilst dispensing said fluid(s), powder(s), seeds or turning over the ground so that said dispensing means or plough describes a single predetermined line image such as the markings of a sports field or a single line symbol or text.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a playing field on which a ground maintenance vehicle is positioned;

FIG. 2 is a side view of the ground maintenance vehicle;

FIGS. 3 to 8 are plan views of the vehicle illustrating different nozzle/roller configurations;

FIGS. 9 to 24 are schematic views of different embodiments of dispensing boxes of the vehicle;

FIGS. 25A and B are end and plan views of a walking floor of a dispensing box;

FIG. 26 shows plan views of a shuffle floor of a dispensing box in different operative positions;

FIGS. 27 to 29 are sketch plan views depicting a method of spiral image marking;

FIGS. 30 to 32 are sketch plan view showing further methods of image marking;

FIGS. 33 to 36 are schematic views of different marking devices, an autonomous robot and a grass cutter.

### DETAILED DESCRIPTION OF THE PREFERRED EMBODIMENT

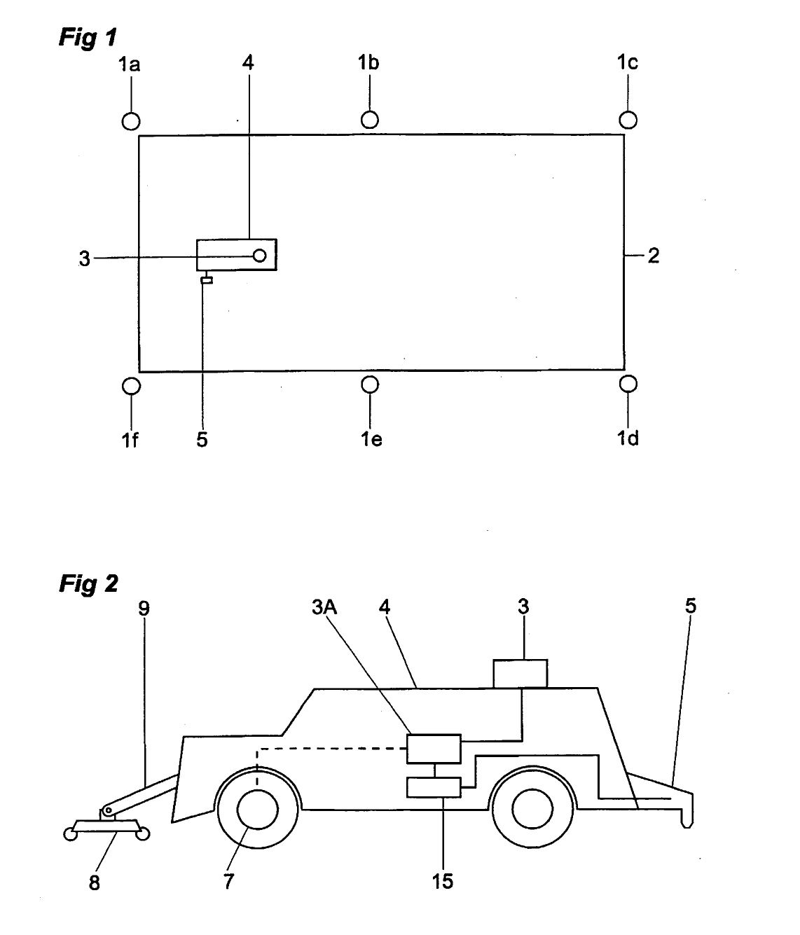

FIG. 1 is a plan view of a turfed sports field 2. An autonomous ground maintenance vehicle in the form of a mower marker vehicle 4 is able to move around the sports field.

FIG. 2 shows the mower marker vehicle 4. It has maintenance equipment in the form of a grass mowing device 8 supported on the chassis 10 of the vehicle 4 by a support 9. At the opposite end of the vehicle marking means in the form of a dispensing device 5 is provided. The vehicle 4 has four wheels 6a to 6d, and an encoder 7 measures the rotation of one of the wheels 6, thereby to provide data representing the distance traveled by the vehicle 4 by means of odometry. The positional data from the detecting means 3 and the encoder 7 is input to guidance means 3A which controls the travel of the vehicle 4 and the operation of the mowing device 8.

As shown in FIG. 1 the sports field 2 is surrounded by fixed reference markers 1a, 1b, 1c, 1d, 1e and 1f. A detecting means 3 is provided on the vehicle 4 for determining the position of the vehicle 4 relative to markers 1a to 1f.

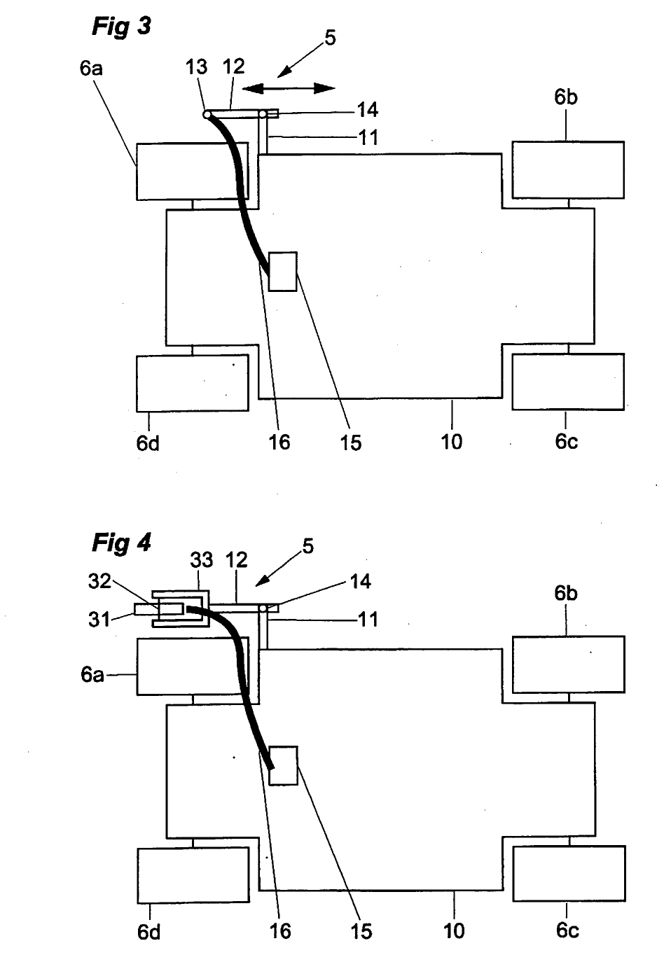

The vehicle 4 has marking means for marking the ground as it travels around the sports field 2 under its own power and guided by guidance means provided by an outboard computer which is responsive to the data generated by the detecting means 3 and the encoder 7. In the embodiment of FIGS. 3 to 8, the dispensing device 5 is adapted to deliver a liquid marking material.

In the embodiment of FIG. 3 the dispensing device 5 comprises a single nozzle 13 mounted on an arm assembly 11, 12 and 14 attached to the chassis 10. The arm 12 is adjustable about a pivot 14 relative to the arm 11, which is fixed to the chassis 10, thus allowing different settings. The nozzle 13 is connected to a material metering device 15 by a plurality of tubes 16(one of which is shown in FIG. 3). Different colored materials are dispensed through each of the tubes 16. A color image can be produced by using the different colors in turn, or a single color can be used to produce a monochrome image. The metering means 15 receives input from the guidance means 3A so as to control the delivery of material, and its color, from the nozzle 13 in accordance with the position of the vehicle on the sports field.

FIG. 4 is similar to FIG. 3 except that the dispensing device 5 comprises a roller 31 instead of the nozzle 13, which rotates on an axle 32 supported by a mounting bracket 33 attached to the adjustable arm 12.

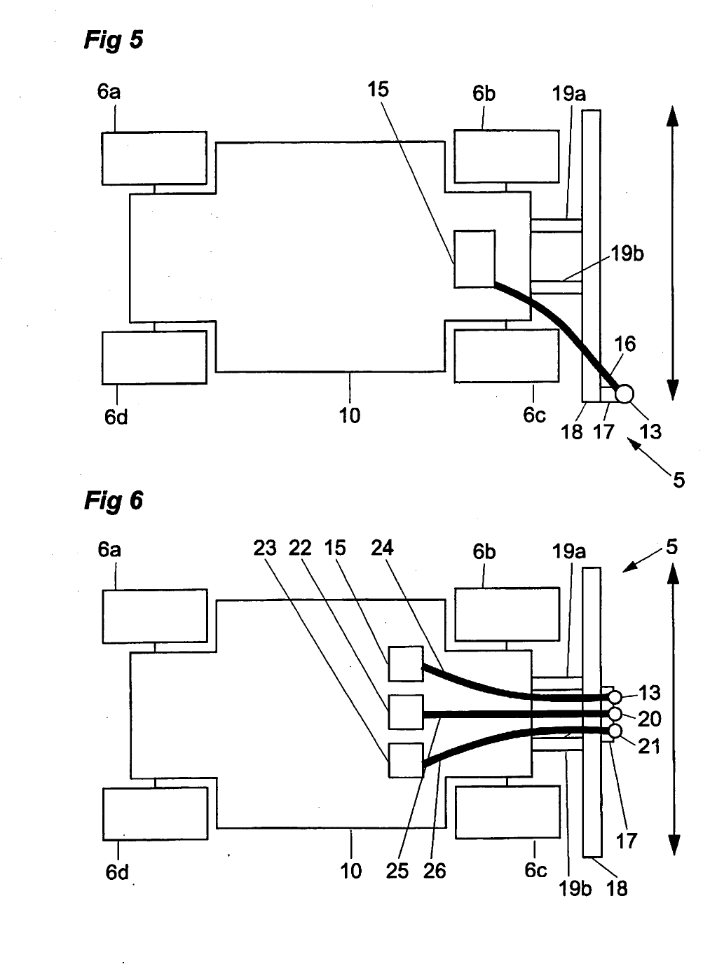

The nozzle 13 in the embodiment of FIG. 5 is mounted on a support plate 17 which can be driven back and forth along a rail 18 extending across the width of the vehicle; the position of the nozzle 13 relative to the rail 18 is controlled by a computer so that as the vehicle moves forward, material can be dispensed across the width of the vehicle to provide unbroken ground coverage. The rail 18 is attached to the vehicle chassis 10 by fixing brackets 19a and 19b. The nozzle 13 is connected to the material dispensing device 15 by a tube 18 which, again, may be one of a plurality of tubes conveying marking material of different colors.

FIG. 6 shows three nozzles 13, 20 and 21 fixed to a common attachment plate 17. The plate 17 moves back and forth along the rail 18 with its position controlled by computer so that as the vehicle moves forward material can be dispensed across the width of the vehicle to provide unbroken ground coverage. Each of the nozzles 13, 20 and 21 are connected to their own material dispensing device 15, 22 and 23 respectively by tubes 24, 25 and 26. Each dispensing device 15, 22 and 23 dispenses different colored materials to produce either a full color image or just a monochrome image.

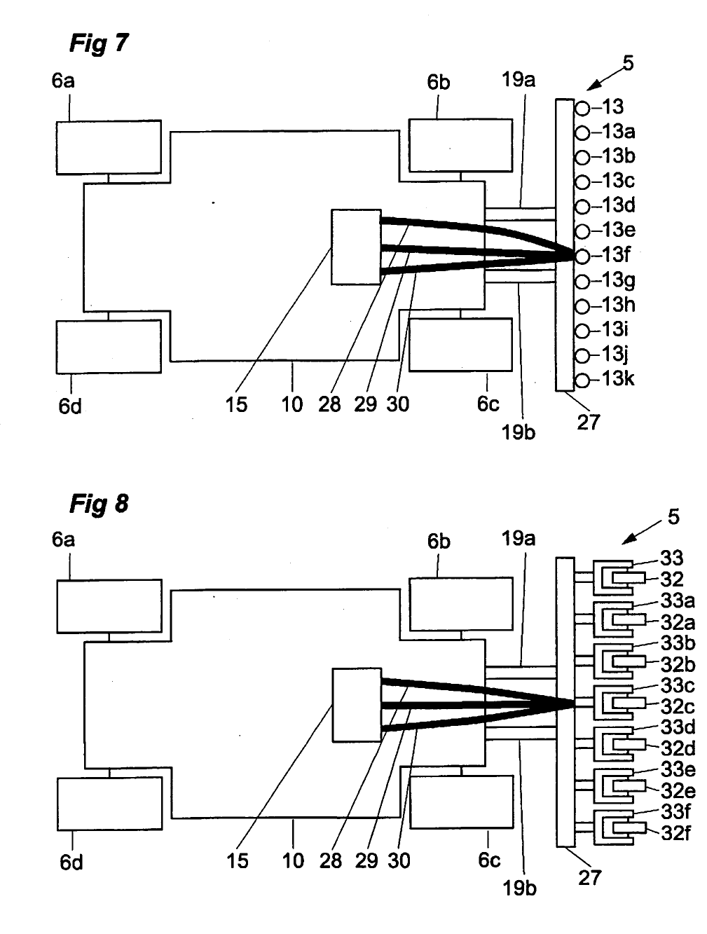

FIG. 7 shows an array of nozzles 13-13k fixed to a rail 27. Each of the nozzles 13-13k is connected to a material dispensing device 15 by three or more tubes 28, 29, 30, which provide different colored materials to the respective nozzles. The tubes 28, 29 and 30 connected to nozzle 13f are the only ones illustrated. As the vehicle moves forward a computer controls which colored materials are dispensed from each of the nozzles 13-13k at any particular time thus enabling any color or monochrome image to be put down on the ground. FIG. 8 is similar to FIG. 7 except that the nozzles are replaced by a series of rollers 32-32f and their associated brackets 33-33f as described for FIG. 4.

FIGS. 3 to 8 relate to dispensing devices 5 for dispensing marking materials in liquid form. However, granular or powdery marking materials may be used and several examples of dispensing devices for such materials will now be described.

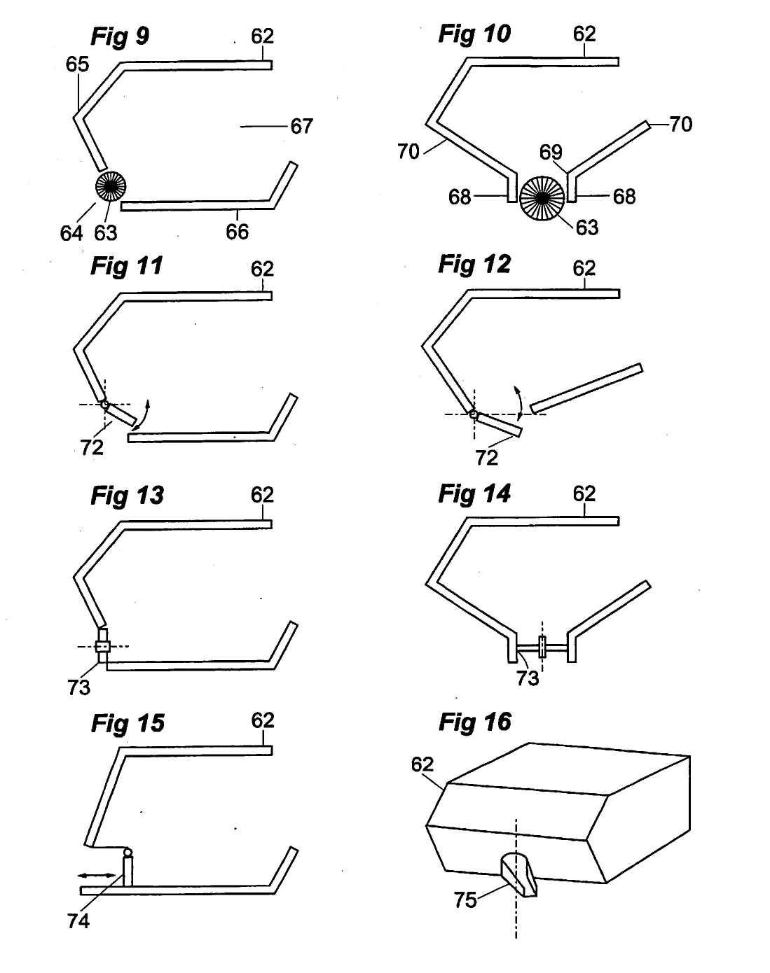

FIG. 9 shows a dispensing device in the form of a box 62 having an inlet 67 for receiving herbicides, fertilizer or seeds in a generally conventional way. It will be appreciated that such materials will also have a marking effect on the ground, although in a less immediate way than a paint or other pigmented material. Thus, the selective application of a weed killer or fertilizer can produce markings by killing the grass or vigorously promoting its growth. Seeds can result in the growth of a different plant from the surrounding turf.

In a lower region of the box 62 there is an exit slot 64 with means for controlling the passage of material. In the embodiment of FIG. 9 the slot 64 is defined between a horizontal bottom wall 66 and a side wall 65 which stops short of the bottom wall 66.

FIG. 10 shows a variant in which the bottom part of the container is formed as a hopper, with a pair of base walls 70 sloping down to a spaced pair of flanges 68 defining the exit slot 69. In both FIGS. 9 and 10 there is a cylindrical brush 63 mounted in the exit slot 64, 69 so that, when stationary, it prevents the passage of the contents of the container whereas, when rotated, it feeds the contents out in a controlled fashion.

FIGS. 11 and 12 show dispensing containers which are generally similar to those in FIGS. 9 and 10 respectively, but which use an oscillating hinged flap 72 instead of the cylindrical brushes 63. FIGS. 13 and 14 show boxes with fans 73 located in the outlet slots.

FIG. 15 shows a box similar to those of FIGS. 9 and 10 but with a flap 74 which is reciprocated like a piston between a position at which it closes the outlet slot and a position at which it is spaced from the outlet slot.

In some embodiments the exit opening may not be a wide slot. For example, fans and piston-type flaps as in FIGS. 13 and 15 may be used to expel material through one or more relatively small outlet openings. As shown in FIG. 16, the material may thus be fed to one or more spouts 75, which may be swiveled automatically to dispense the material.

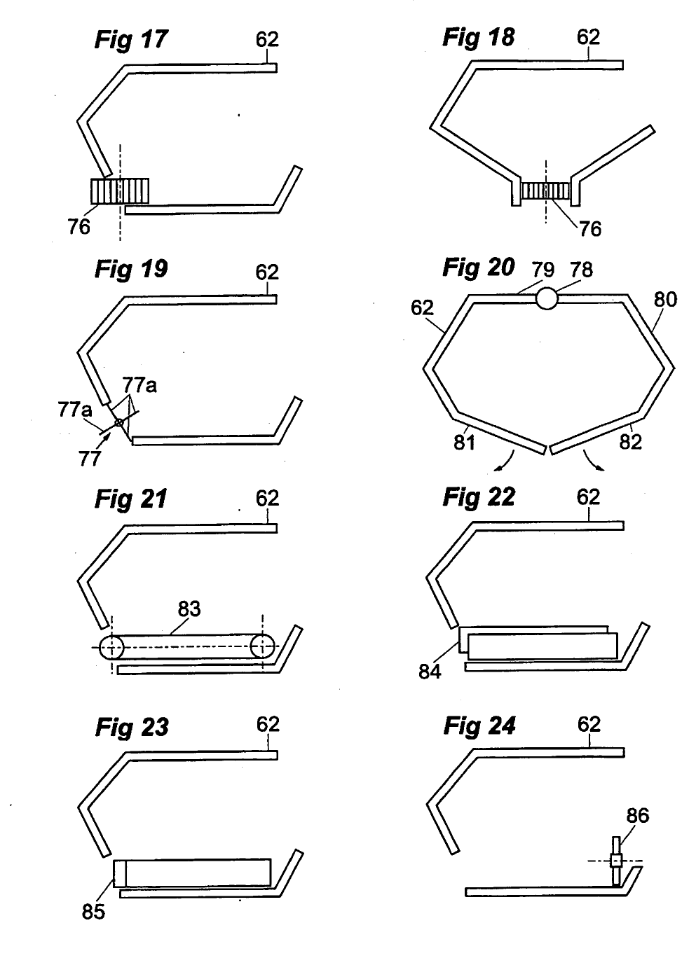

FIGS. 17 and 18 show analogous boxes using rotatable fanned discs 76.

FIG. 19 shows a box like that of FIG. 9 but with the outlet slot controlled by a rotating rake 77. This is similar to the brush used in FIGS. 9 and 10 but with tines 77a instead of bristles.

FIG. 20 shows a box having two portions 79 and 80 connected via an upper hinge 78 so that their lower edges 81 and 82 can be together as shown, or progressively spaced apart to provide a suitable exit slot.

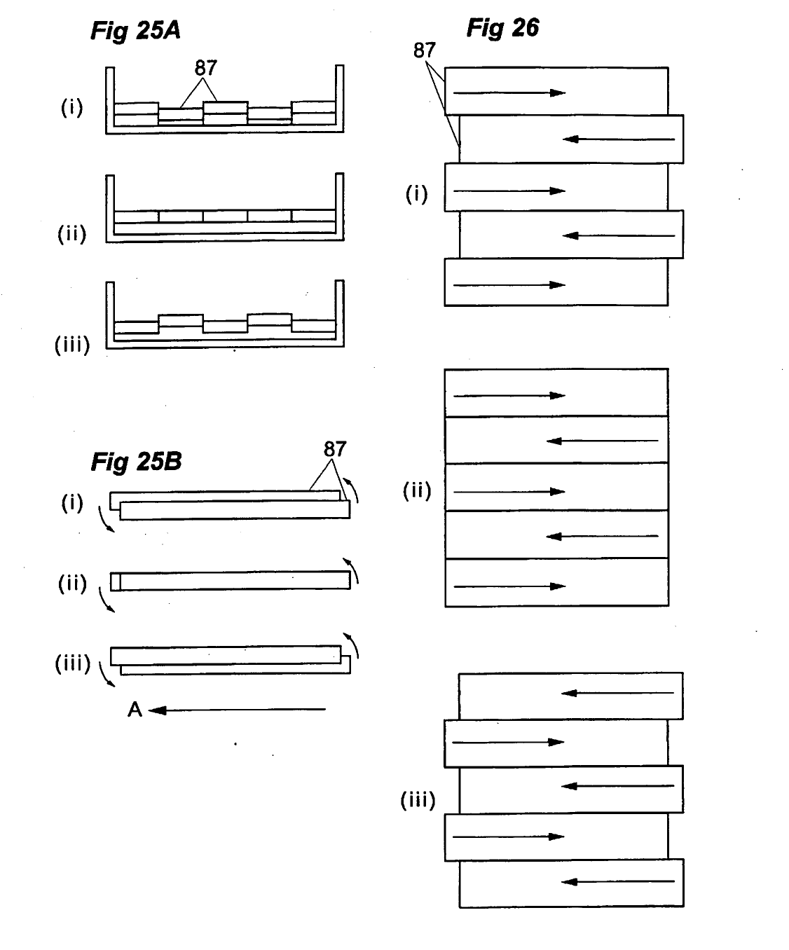

Within a dispensing container, the feeding of material to the exit outlet(s) may depend on gravity and/or be mechanically assisted. FIG. 21 shows a container generally as in FIG. 9 with a horizontally extending conveyor 83. FIG. 22 shows a walking floor 84. As shown in FIG. 25, this may be made up of flat panels 87 along the base of the container which move in a reciprocating motion provided by a powered cam shaft. The walking motion may be generated by each panel being delayed by 180 degrees on the cam set up from the panels on either side. Arrow A of FIG. 25B indicates the direction of movement.

FIG. 23 shows a container with a shuffle floor 85. As shown in FIG. 26 this may be made up of one or a plurality of panels 87 along the base of the container which move in a linear fashion back and forth allowing the material to move to the exit slot. When a number of panels are used the direction of the motion of one panel to the next may be opposite.

FIG. 24 shows a box with an internal fan 86 on the opposite side of the box from the exit opening, for blowing material towards and through the opening.

Most of the boxes described include one or more mechanisms that require to be driven. They will generally be powered by their own source, (motor, internal or external to the dispensing unit) electric, air or other fluid motor

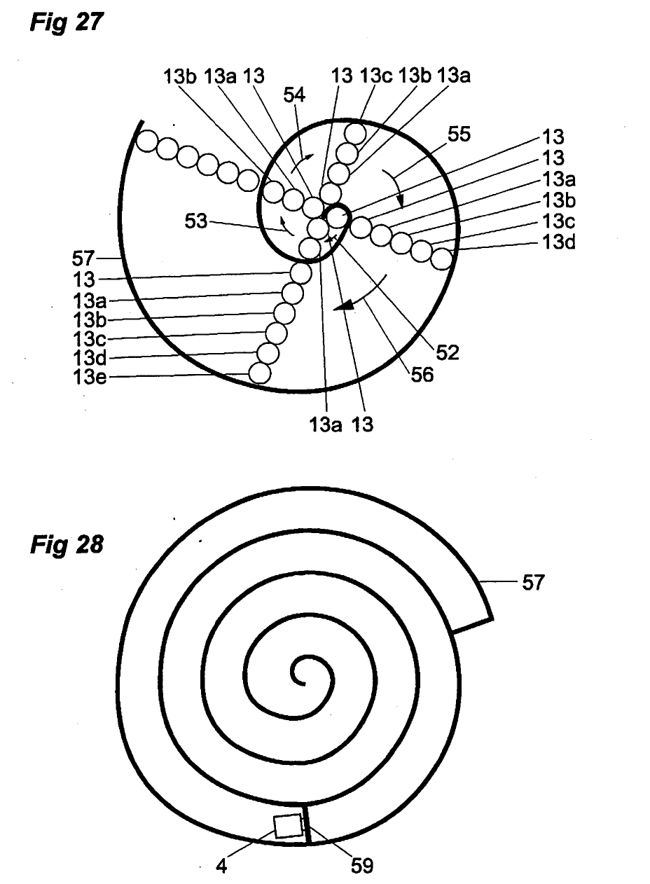

FIG. 27 depicts the spiral methodology of generating a circular logo using only the nozzles 13-13e of the dispensing equipment to show how the material is dispensed according to the digital information collected by the spiral rasterization of the logo. For the purposes of FIG. 27 the dispensing equipment has 6 nozzles 13-13e and is mounted on the back of the vehicle (not shown). Only the nozzles in use at any point on the traveled path are shown. The vehicle starts off in the direction of arrow 52 with the innermost nozzle 13 operating on its own. As the vehicle progresses, the computer operates nozzle 13a along with 13 in accordance with the digitized information. The vehicle continues in the direction of arrow 53 and operates an extra nozzle 13b. The computer operates one nozzle after another as the vehicle progresses around on a constantly expanding radius in the direction of arrows 54-56 until all six nozzles 13-13e are operating. The vehicle then continues with all six nozzles 13-13e operating until the full image is generated. Each nozzle may dispense any of the available colors, or a mixture of them, or no material at all at any time on the route of the spiral thus generating a full color or a monochrome image. The line 57 depicts the outside border of the material dispensed on each turn of the vehicle.

FIG. 28 shows the autonomous mower marker 4 with dispensing equipment 59 part way around the circular spiral illustrated by line 57. The full logo image is shown by the outermost portion of the line 57.

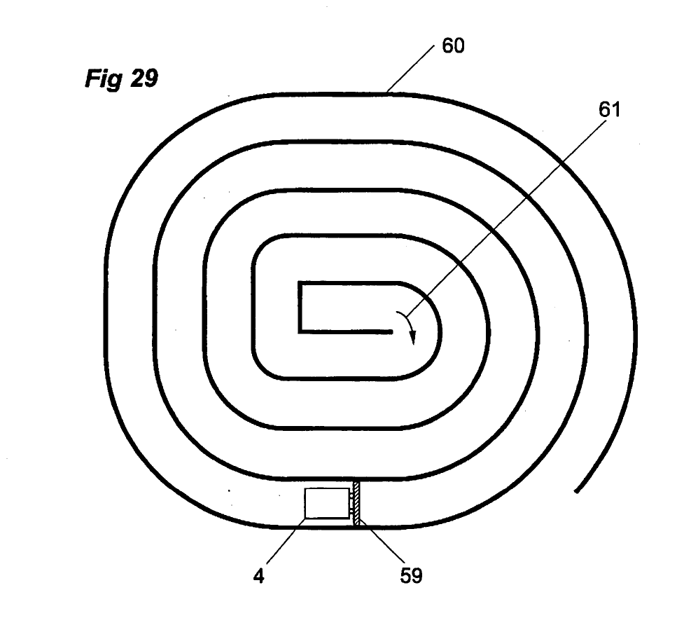

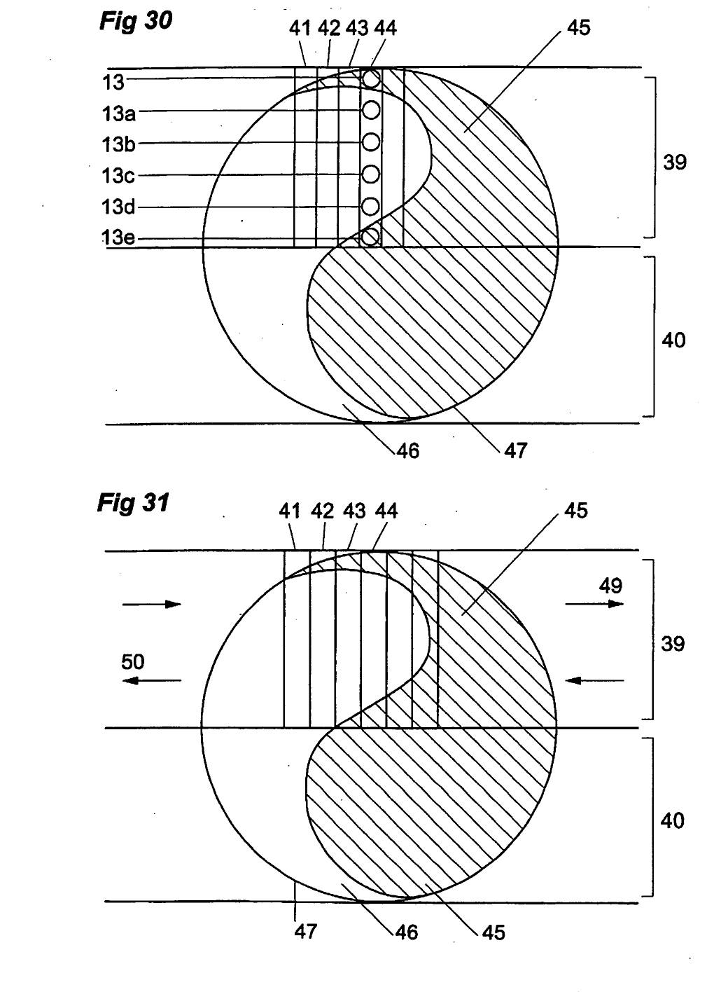

FIG. 29 shows the autonomous mower marker vehicle 4 with dispensing equipment 59 part way around a spiral with the difference being that the spiral is rectangular and is illustrated by line 60. The center of the rectangular spiral may allow the full width of the dispensing equipment 59 to be used as the vehicle moves in the direction of arrow 61.

FIG. 30 shows a circular image 47 having two sections 45 and 46 black and white respectively. The image is split into two bands 39 and 40 which represent the width of the vehicle dispensing apparatus as well as demonstrating how the computer first breaks down the image 47. The bands 41-44 represent how the first breakdown band 39 is further broken down and carries on across the whole image. The width of these bands is variable depending on the resolution of image required. The bands 41-44 are broken down by the computer along their lengths to the pitch between each of the nozzles 13-13e. The computer then controls which colored material is dispensed at what position as the vehicle moves along band 39 such that at the point in time shown in FIG. 30 nozzles 13 and 13e are instructed to dispense black material and nozzles 13a-13d are instructed to dispense white material. FIG. 31 shows the same image 47 as in FIG. 30 with black and white areas 45 and 46 and represents a methodology of image marking. The image 47 is broken down in exactly the same way as for the methodology represented in FIG. 30 but the dispensing instructions from the computer are different in that the vehicle 35 travels in two directions illustrated by arrows 49 and 50 over the same area dispensing only one colored material in each direction before displacing itself to travel over the band 40.

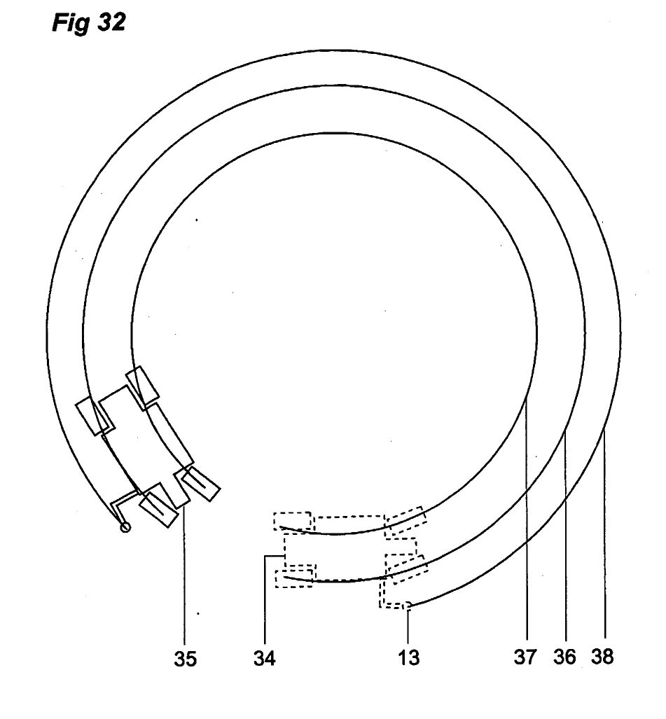

FIG. 32 depicts a methodology of generating a line circle 38 whereby the material is dispensed from the nozzle 13 of a dispensing device as shown in FIG. 3. As shown in FIG. 32, the vehicle moves from its start position 34 around in a circle depicted by the wheels' path 36 and 37 to its end position 35.

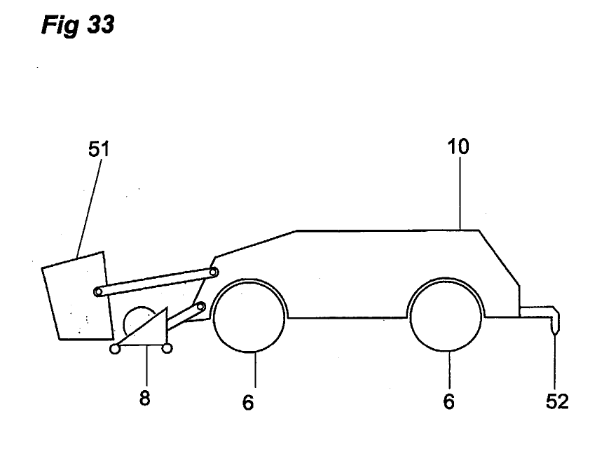

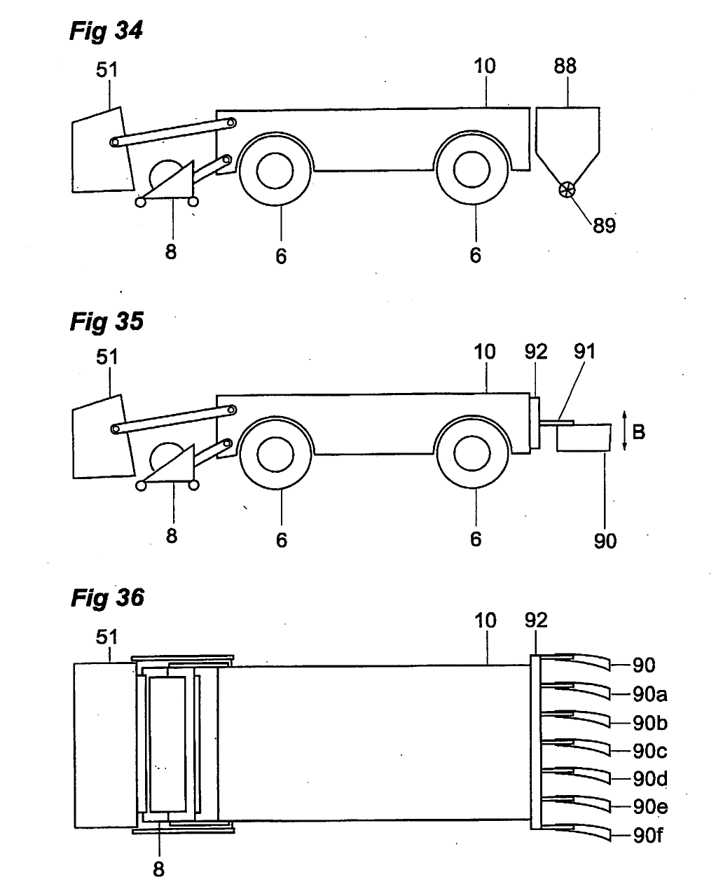

FIG. 33 shows an autonomous mower marking vehicle with a chassis 10, with ground engaging wheels 6 supporting a grass cutting device 8, a grass collection box 51 and a material dispensing device and nozzle 52. FIG. 34 shows a similar machine to FIG. 33 with the material spray dispensing device 52 replaced by a dispensing hopper 88 which feeds the material onto the ground via a rotating brush 89.

Images may be transferred to the ground by upturning the surface by ploughing. As shown in FIG. 33, FIG. 35 has all the basic attributes of the invention except that the marking means comprises a ploughing assembly instead of a dispensing device. The plough blade 90 is attached to a supporting arm 91 which may move up and down in the direction of arrow B on the slide bar 92 under the control of the controlling computer, for example as the vehicle moves forward the plough may be moved in and out of the ground to produce a dashed line. A number of plough blades 90-90f as shown in FIG. 36 may be attached to the sliding bar 92 show and may be operated up and down individually or as a whole unit depending on the requirements of the image to be produced.

A large image 47 for a sports field can be derived from a smaller version of the same image by subdividing the smaller image into cells or pixels. Each pixel corresponds to a respective nozzle in a particular position. The row of nozzles (FIG. 7) thus corresponds to a line of pixels. As the nozzles advance over the ground, they lay down the required image as pixels, scaled up from the original image.

The image 47 may be put down on a surface anywhere by the user defining the position in the vehicles map of its work environment (FIG. 1) such that each line of pixels has a fixed position (an X-Y co-ordinate) on the surface to be painted. The orientation of each pixel line must also be defined, as the orientation of each pixel line relative to the next must not change or the image may be distorted. The vehicle 4 may be able to calculate its position and heading within its working environment (FIG. 1) by utilizing the sensor 3 that may be a rotating infra-red emitter/detector. An infra-red signal will be emitted from said sensor 3 and reflected back to said sensor from a plurality of reflective targets 1a-1f in known positions on the periphery of the vehicles 4 working environment. The reflected signals from said targets 1a-1f may then be used to calculate the position and heading of the vehicle with reference to the known positions of the markers or targets using known mathematical methods of triangulation. A further sensor which may be the rotary encoder 7, mounted on one or more of the vehicle's wheels to measure linear distance traveled by the vehicle 4, may be used to cross reference with the linear distance traveled as calculated from the output of the infra-red emitter/detector in order to average a positional error between the two said sensors. The vehicle 4 may then move itself into the correct position (X-Y co-ordinate) and heading on the surface to be painted and the or each nozzle may dispense the color corresponding to the pixilated image held in the vehicle memory. The color required for a pixel may be dispensed by any of the nozzles 13, 20 and 21 individually for a single color or any combination of the nozzles 13, 20 and 21 may be used together to generate any color required (i.e. the sprays mix together). When one line is complete the vehicle may move on to the next position corresponding to the next line of pixels by using the infra-red emitter/detector and encoder devices to ensure the position is correct, the next line of pixels may then be dispensed. The vehicle 4 may either be moving or stationary while each line of pixels is applied.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. An autonomous ground maintenance vehicle comprising:
guidance means for guiding the ground maintenance vehicle on the ground area to be maintained;
position sensing means for determining the position of the vehicle;
maintenance equipment for performing a ground maintenance operation;
marking means for marking the ground; and
control means for the marking means, the control means being responsive to the position sensing means for controlling the marking means to mark the ground at predetermined positions.

2. An autonomous ground maintenance vehicle as claimed in claim 1, wherein the marking means comprises delivery means having an outlet for delivering a marking material to the ground.

3. An autonomous ground maintenance vehicle as claimed in claim 2, wherein the delivery means comprises a plurality of outlets.

4. An autonomous ground maintenance vehicle as claimed in claim 3, wherein each outlet is independently controlled by the control means.

5. An autonomous ground maintenance vehicle as claimed in claim 3, wherein at least one of the outlets is supplied independently from at least one other of the outlets.

6. An autonomous ground maintenance vehicle as claimed in claim 5, wherein at least one of the outlets is supplied with a material of a different color to a material supplied to at least one other of the outlets.

7. An autonomous ground maintenance vehicle as claimed in claim 3, wherein the or each outlet is mounted on traversing means for traversing the or each outlet across the width of the vehicle.

8. An autonomous ground maintenance vehicle as claimed in claim 7 wherein the position of the or each outlet is controlled by the control means.

9. An autonomous ground maintenance vehicle as claimed in claim 2, wherein the outlet or at least one of the outlets is a spray nozzle.

10. An autonomous ground maintenance vehicle as claimed in claim 2, wherein the delivery means comprises at least one ground engaging roller.

11. An autonomous ground maintenance vehicle as claimed in claim 2, wherein the marking material is a pigmented material.

12. An autonomous ground maintenance vehicle as claimed in claim 2, wherein the marking material is a growth modifying material.

13. An autonomous ground maintenance vehicle as claimed in claim 12, wherein the growth modifying material to be delivered is a fertilizer or herbicide.

14. An autonomous ground maintenance vehicle as claimed in claim 12, wherein the growth modifying material is seed.

15. An autonomous ground maintenance vehicle as claimed in claim 2, wherein the material to be delivered is gravity fed to the delivery means.

16. An autonomous ground maintenance vehicle as claimed in claim 2, wherein the delivery means further comprises feed means for feeding the material to the outlet.

17. An autonomous ground maintenance vehicle as claimed in claim 16, wherein the feed means comprises vibrating means for vibrating a surface over which the material is conveyed to the outlet.

18. An autonomous ground maintenance vehicle as claimed in claim 2, wherein the delivery means comprises a container for the material, the container comprising two housing parts which cooperate to provide a slot constituting the outlet opening.

19. An autonomous ground maintenance vehicle as claimed in claim 18, wherein the housing parts are displaceable relatively to each other to adjust the width of the slot

20. An autonomous ground maintenance vehicle as claimed in claim 1, wherein the position sensing means comprises detecting means and at least three reference markers which are located adjacent to the periphery of the ground area to be maintained and are detected by said detecting means.

21. An autonomous ground maintenance vehicle as claimed in claim 1, wherein the position sensing means comprises odometry means.

22. An autonomous ground maintenance vehicle as claimed in claim 1, wherein direction detection means is provided for detecting the direction of travel of the vehicle.

23. An autonomous ground maintenance vehicle as claimed in claim 1, wherein the maintenance equipment comprises turf maintenance equipment.

24. An autonomous ground maintenance vehicle as claimed in claim 23, wherein the turf maintenance equipment comprises grass cutting means.

25. An autonomous ground maintenance vehicle as claimed in claim 1, wherein the marking means comprises a plough having at least one blade, the blade height being controlled by the control means

26. An autonomous ground maintenance vehicle as claimed in claim 1, wherein the maintenance equipment is releasably connected to a frame of the vehicle.

27. A method of creating an image with a ground maintenance vehicle comprising the steps of:
rasterizing a required image to provide a digital representation of the image;
controlling the delivery means by the control means in accordance with the position of the vehicle to reproduce the required image on the ground surface.

28. A method of creating an image as claimed in claim 27, comprising the step of rasterizing the image in a spiral fashion from the center of the image.

29. A method of creating an image as claimed in claim 27, further comprising the step of rasterizing the image at 90 degrees to the direction of travel of the vehicle.

30. A method of creating an image as claimed in claim 27, comprising the steps of:
rasterizing the required image to a maximum width corresponding to the maximum ground marking length of the marking means measured in the direction of travel of the vehicle; and
rasterizing the required image perpendicular to the direction of travel of the vehicle.

31. A method of creating an image as claimed in claim 27, further comprising the steps of:
controlling the dispensing means by the control means to dispense a marking material of a first color,
moving the vehicle along the path as the dispensing means dispenses the first color,
controlling the dispensing means by the control means to dispense a marking material of a second color,
moving the vehicle along the path as the dispensing means dispenses the second color.
